(19) United States
(12) Patent Application Publication
(10) Pub. No.: US 2005/0167345 A1
(43) Pub. Date: Aug. 4, 2005

(54) Management arrangement

(76) Inventors: Riccardo Arthur De Wet, Gordon's Bay (ZA); Daniel A. Corte, Strand (ZA)

Correspondence Address: CLARK & ELBING LLP, 101 FEDERAL STREET, BOSTON, MA, 02110, US

(21) Appl. No.: 10/503,535

(22) PCT Filed: Dec. 2, 2002
(86) PCT No.: PCT/IB02/05052

(30) Foreign Application Priority Data
Feb. 4, 2002 (ZA) 2002/0955

(51) Int. Cl. B01D 35/14

(52) U.S. Cl. 210/85; 210/86; 210/96.1; 210/192; 210/149; 210/745; 210/791; 210/143; 4/508; 4/496; 210/169; 210/748

(57) ABSTRACT

The invention discloses a management arrangement for a swimming pool. The arrangement includes a number of sensors being adapted to measure variables and generate input data relating to a swimming pool. The input data is processed by a processing unit to generate output data, which data is then used by an actuator to control equipment. Various operating parameters are programmable into the processing unit via an operator interface.

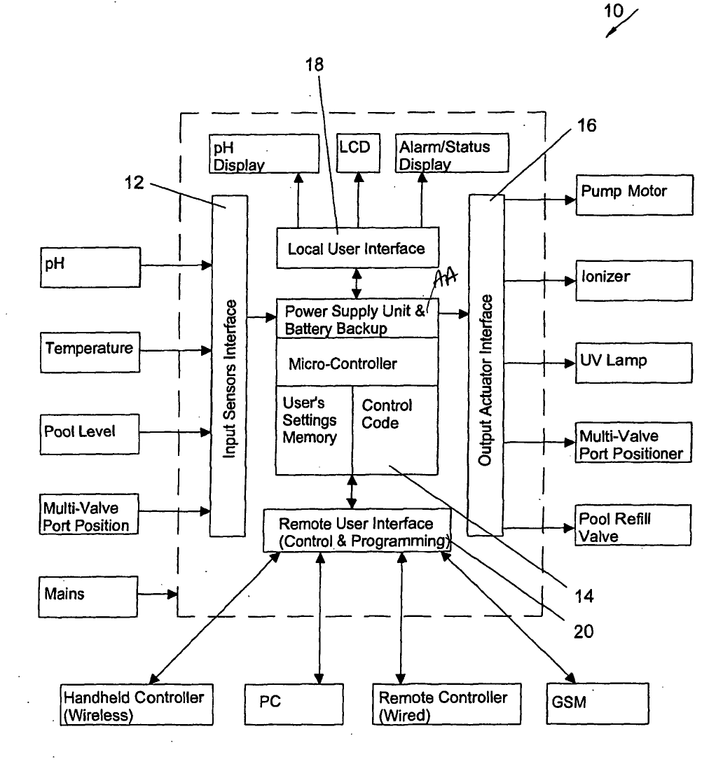

### FIELD OF INVENTION

The present invention relates to a management arrangement.

More particularly, the present invention relates to a management arrangement for regulating water in swimming pools.

### BACKGROUND TO INVENTION

Water contained in swimming pools needs to be treated on a regular basis, e.g. to prevent the water from stagnating and becoming infested with algae. This treatment requires the cleaning of the swimming pool filter, e.g. backwashing, and the addition of certain chemicals, such as acid and chlorine, to the water. These chemicals are corrosive and can be dangerous if not handled or stored correctly. If an excessive quantity of the chemicals is added to the water, the water will also become unbalanced and will display unwanted characteristics, e.g. such as becoming milky.

One method of overcoming these problems is to use a chlorinator unit, which generates chlorine by the dissociation of salt. This allows a regular supply of chlorine into the water without requiring constant supervision. However, a person must still manually backwash the swimming pool and check whether enough salt is available in the water for the chlorinator unit to operate.

It is an object of the invention to suggest a management arrangement, which will assist in overcoming these problems.

### SUMMARY OF INVENTION

According to the invention, a management arrangement for a swimming pool includes a number of sensors being adapted to measure variables and generate input data relating to a swimming pool; a processing unit being adapted to receive the input data and to generate output data; an actuator adapted to control equipment in response to the output data; and an operator interface adapted to allow programming of operating parameters into the processing unit.

The arrangement may include a swimming pool pump and a multi-valve port.

The arrangement may include an ionising unit.

The ionising unit may be adapted to generate activated copper ions in swimming pool water.

The arrangement may include an ultra-violet unit.

The ultra-violet unit may include a germicidal lamp with an output of between 55 Watt and 115 Watt.

The arrangement may include a pool refill valve adapted to open or close a water supply for allowing extra water to be poured into the swimming pool.

The sensors may include at least one pH sensor for measuring the pH of the swimming pool water.

The sensors may include at least one temperature sensor for measuring the temperature of the swimming pool water.

The sensors may include at least one water level sensor for measuring the level of the swimming pool water.

The sensors may include at least one valve position sensor for determining the position of a multi-valve port.

The operator interface may include a local interface and a remote interface.

The local interface may include a display panel adapted to display a pH value of the swimming pool water.

The local interface may include a display panel adapted to display an operational status of the management arrangement.

The local interface may include a LCD display panel adapted to display a instructions on quantities of chemicals to be added to swimming pool water.

The remote interface may be used to program the processing unit with operating parameters.

The remote interface may be operatively connected to the processing unit via infra-red, radio or cellular signals.

The remote interface may be a remote control unit, a computer or a mobile telephone.

The management arrangement may include a battery.

Also according to the invention, a method of managing a swimming pool includes the steps of selecting a series of operating parameters relating to a swimming pool; of measuring variables relating to a swimming pool; of comparing the variables with the operating parameters to determine a status of the swimming pool; of displaying the status on an operator interface; and of providing instructions on altering the variables to maintain an optimal status.

The method may include the step of generating an alarm if the status varies sufficiently from the optimal status.

The method may include the step of automatically backwashing a swimming pool as discrete time intervals.

The method may include the steps of activating purification equipment, such as a ionisation unit and a ultra-violet unit, in accordance with the operating parameters.

The invention also extends to the combination of a swimming pool and a management arrangement as set out herein.

### BRIEF DESCRIPTION OF THE DRAWING

The invention will now be described by way of example with reference to the accompanying schematic drawing.

In the drawing there is shown a block diagram of a management arrangement in accordance with the invention.

### DETAILED DESCRIPTION OF THE DRAWING

Referring to the drawing, a block diagram of a management arrangement in accordance with the invention, generally indicated by reference numeral 10, is shown. The management arrangement 10 is used for regulating the purity and flow of water in swimming pools and is operatively joined to a swimming pool pump and filter. The pump is provided with a multi-valve port having commonly known functions such as “filter”, “backwash”, “rinse”, “waste”, and “bypass”.

The management arrangement 10 includes an input sensor interface 12 adapted to receive input data regarding the pH, temperature and water level of the swimming pool water, and the selected function of the multi-valve port. The input data is transmitted to a micro-controller 14, which is programmed with software adapted to interpret the information. The software is programmable with certain settings, e.g. the duration of operation of the swimming pool pump, the frequency that the filter should be backwashed, etc. The micro-controller 14 is further operatively joined to an output actuator interface 16, a local operator interface 18 and a remote operator interface 20.

The output actuator interface 16 is used to operate water purity and flow equipment, such as the swimming pool pump, the multi-valve port, an ionising unit, an ultra-violet unit and a pool refill valve.

The local operator interface 18 displays information regarding the input data and the operational status of the management arrangement 10. The remote operator interface 20 is used to control the operation of the management arrangement 10 and to program the required settings into the software of the micro-controller 14.

During use, a person activates the management arrangement 10 and enters the required settings into the software. The management arrangement 10 will then automatically activate the swimming pool pump at the programmed intervals and filter the swimming pool water. While idling between the filtration cycles, the pH of the water is displayed on the local user interface 18. The water level of the pool is also checked and, if required, is topped up by opening the pool refill valve.

The pH value of the water is constantly monitored. When the pH value varies from the ideal value, an indicator on the local operator interface 18 will burn red or yellow. The indicator will burn constantly and will start flashing when the weekly maintenance time arrives. The management arrangement 10 guides a person through the maintenance procedure by displaying the steps to be followed on a LCD (liquid crystal display) on the local operator interface 18. The user will be prompted to add the correct amount of chemical needed to balance the pool (according to the programmed pool size and the actual pH value).

During a filtration cycle, the swimming pool pump is started, the ionising unit is switched on. After water circulation has commenced, the ultra-violet unit is switched on.

The ionising unit can operate in a boost, summer or winter setting. The boost setting is primarily for new swimming pools where maximum ionisation is required. After the swimming pool is stabilised the ionisation setting is reduced and regulated to ensure that the correct amount of activated copper ions are present in the water as the water temperature fluctuates between summer and winter temperatures. The amount of ionisation is displayed on the local operator interface.

The ultra-violet unit has a germicidal lamp with an output of between 55 Watt and 115 Watt and functions to destroy all water borne bacteria passing therethrough. The ultra-violet unit allows chemical-free disinfection of the water and is also able to remove combined chlorine molecules (chloramines and organic pollutants).

A backwash cycle can be performed either after the termination of each filtration cycle or after termination of the last filtration cycle in each day.

The management arrangement 10 automatically operates multi-valve port, i.e. filter—backwash—rinse—filter, and also switches the swimming pool pump on and off as needed.

The management arrangement 10 is further provided with a secondary battery power supply, so that in the event of a mains power failure, any backwash cycle is terminated and the multi-valve port is returned to its filter position, thereby assuring that no water drains out from the swimming pool. Although a person's settings are retained and the real time clock is unaffected, the ionising and ultra-violet units will be suspended until the mains power is restored.

A person can bypass any programming schedule with a “manual” mode. This allows any test/maintenance of the swimming pool to be performed under their supervision. A wireless hand held remote controller is provided so that the person does not need to open the management system's enclosure to program or fully control the manual operation.

The management arrangement 10 can be interfaced with digital communication equipment such as computers and cellular devices to allow automated remote control.

1. A management arrangement for a swimming pool, which includes a number of sensors being adapted to measure variables and generate input data relating to the swimming pool; a processing unit being adapted to receive the input data and to generate output data; an actuator adapted to control equipment in response to the output data; an operator interface adapted to allow programming of operating parameters into the processing unit; an ionising unit and an ultra-violet unit.

2. A management arrangement as claimed in claim 1, wherein the ionising unit is adapted to generate activated copper ions in swimming pool water.

3. A management arrangement as claimed in claim 1, wherein the ultra-violet unit includes a germicidal lamp with an output of between 55 Watt and 115 Watt.

4. A management arrangement as claimed in claim 1, wherein the equipment includes a pool refill valve adapted to open or close a water supply for allowing extra water to be poured into the swimming pool.

5. A management arrangement as claimed in claim 1, wherein the sensors include at least one valve position sensor for determining the position of a multi-valve port.

6. A management arrangement as claimed in claim 1, wherein the operator interface includes a local interface and a remote interface.

7. A management arrangement as claimed in claim 6, wherein the local interface includes a display panel adapted to display a pH value of the swimming pool water.

8. A management arrangement as claimed in claim 6, wherein the local interface includes a display panel adapted to display an operational status of the management arrangement.

9. A management arrangement as claimed in claim 6, wherein the local interface includes a display panel adapted to display a pH value of the swimming pool water and a display panel adapted to display an operational status of the management arrangement.

10. A management arrangement as claimed in claim 6, wherein the remote interface is used to program the processing unit with operating parameters.

11-26. (canceled)

27. A method of managing a swimming pool, comprising the steps of
(i) selecting a series of operating parameters relating to the swimming pool;
(ii) measuring variables relating to the swimming pool;
(iii) comparing the variables with the operating parameters to determine the status of the swimming pool;
(iv) displaying the status on an operator interface;
(v) providing instructions on altering the variables to maintain an optimal status; and
(vi) activating a purification equipment,
wherein the purification equipment is an ionisation unit and an ultra-violet unit.

28. A method as claimed in claim 10, further comprising the step of
(vii) generating an alarm if the status varies sufficiently from the optimal status
